(19) United States
(12) Patent Application Publication
(10) Pub. No.: US 2011/0033770 A1
(43) Pub. Date: Feb. 10, 2011

(54) FUEL CELL STACK HAVING SINGLE BODY SUPPORT

(76) Inventors: Kyong Bok MIN, Gyunggi-do (KR); Jae Hyuk JANG, Gyunggi-do (KR); Sung Han KIM, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/565,667

(22) Filed: Sep. 23, 2009

(30) Foreign Application Priority Data
Aug. 5, 2009 (KR) 10-2009-0072003

(51) Int. Cl. H01M 8/10

(52) U.S. Cl. 429/468

(57) ABSTRACT

Disclosed is a fuel cell stack having a single body support. The fuel cell stack includes a plurality of single body fuel cells each including a single body support having a plurality of cylindrical supports and a connector for connecting the cylindrical supports in parallel, a unit cell having a cathode layer, an electrolyte layer and an anode layer sequentially formed on an outer surface of the single body support and a connection member protruding outward from the cathode layer on one side of an outer surface of the cathode layer and spaced apart from the anode layer, and a plurality of connection plates which are alternately stacked with the single body fuel cells and in which one surface of the connection plates is in contact with the anode layer and the other surface thereof is in contact with the connection member, wherein the connection plates are made of metal to thus obviate a need for an additional current collector and are used to collect current.

### CROSS REFERENCE TO RELATED APPLICATION

This application claims the benefit of Korean Patent Application No. 10-2009-0072003, filed Aug. 5, 2009, entitled “Fuel cell stack comprising single body support”, which is hereby incorporated by reference in its entirety into this application.

### BACKGROUND OF THE INVENTION

1. Technical Field

The present invention relates to a fuel cell having a single body support.

2. Description of the Related Art

A fuel cell is a device for directly converting the chemical energy of a fuel (hydrogen, LNG, LPG, etc.) and air into electric power and heat using an electrochemical reaction. Unlike conventional techniques for generating power including combustion of fuel, generation of steam, operation of a turbine and operation of a power generator, the fuel cell has neither a combustion procedure nor an operator and is thus regarded as a novel power generation technique which results in high cell performance without causing any environmental problems.

FIG. 1 shows the principle behind the operation of a fuel cell.

With reference to FIG. 1, hydrogen (H₂) is supplied to an anode 1 and is then decomposed into protons (H⁺) and electrons (e⁻). The protons are transferred to a cathode 3 via an electrolyte 2. The electrons pass through an external circuit 4 causing current to flow. At the cathode 3, the protons and the electrons are combined with oxygen in the air to produce water. The chemical reaction of the fuel cell 10 is represented by Reaction 1 below.

Reaction 1

Anode: H₂→2H⁺+2e⁻

Cathode: 1/2O₂+2H⁺+2e⁻→H₂O

Total Reaction: H₂+1/2O₂H₂O

Specifically, the fuel cell performs the function required of the cell by passing the electrons separated in the anode 1 through the external circuit 4 so that current is produced. The fuel cell 10 discharges air pollutants such as SOx and NOx in scarce amounts and generates a small amount of carbon dioxide and is thus a pollution-free power generator, and is also advantageous in terms of producing very little noise and not causing any vibrations.

Examples of fuel cells include a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and so on. In particular, the SOFC enables high-efficiency power generation and composite power generation of coal gas-fuel cell-gas turbine and is variable in power generation capacity and is thus suitable for use in small and large power plants or as a distributed power source. Hence, the SOFC is essential for realizing the hydrogen-based society of the future.

However, actual use of the SOFC incurs the following problems which need to be solved.

First, the SOFC has poor durability and reliability. Because the SOFC operates at high temperature, its performance is decreased due to a heat cycle. In particular, in the case where the anode or the cathode is used as a support for other elements, when the size of the cell is increased, durability and reliability of parts thereof may be drastically deteriorated because of the properties of the ceramic which is used.

Second, the SOFC makes it difficult to collect current. According to conventional techniques, current is collected by using metal foam inside the unit cell and metal wires outside the unit cell. However, in such a structure, as the size of the cell increases, the amount of expensive metal wires increases, undesirably increasing the manufacturing cost and complicating the structure, thus making it difficult to put into mass production.

Third, the SOFC makes it difficult to connect the unit cell to a manifold. The manifold for supplying fuel such as hydrogen to the unit cell is mainly made of metal, whereas the unit cell is made of ceramic. Thus, in order to connect the metal and the ceramic which are different from each other, a brazing process is used. However, the brazing process is disadvantageous because the unit cell may be clogged or it may be welded poorly, as this is dependent on the speed of increasing the voltage of the inductive coil in the welding procedure, the time that the voltage is maintained, and the cooling conditions following the brazing process.

Fourth, the SOFC is difficult to mold. According to conventional techniques, a ceramic molded body having a predetermined diameter is produced through a typical extrusion process. However, the mixing paste used for the extrusion process contains 15˜20% water and thus should be very carefully dried for a long period of time. When the drying process is performed for a short period of time, internal stress occurs and thus the ceramic molded body may crack. Also, it is difficult to vary the shape of the produced ceramic molded body.

Fifth, in the case of a multi-cell type SOFC, a cell stack should be formed from a plurality of unit cells which are aligned. However, the formation of the stack requires complicated connections between current collectors and the respective unit cells, thus increasing the fabrication and process costs compared to cell performance. Furthermore, as the number of unit cells increases, current collection resistance increases, undesirably reducing cell performance.

Sixth, in the multi-cell type SOFC, in the case where performance of the fuel cell is deteriorated attributable to the formation of hot spots on any unit cell among the plurality of unit cells, it is difficult to determine the presence of such a problematic unit cell.

### SUMMARY OF THE INVENTION

Accordingly, the present invention has been made keeping in mind the problems encountered in the related art and the present invention intends to provide a fuel cell stack in which single body supports and connection plates are optimally configured, thus facilitating the collection of current, ensuring high cell performance and simplifying the fabrication process.

An aspect of the present invention provides a fuel cell stack, including a plurality of single body fuel cells each including a single body support composed of a plurality of cylindrical supports and a connector for connecting the plurality of cylindrical supports in parallel, a unit cell having a cathode layer, an electrolyte layer and an anode layer sequentially formed on an outer surface of the single body support, and a connection member formed to protrude outward from the cathode layer on one side of an outer surface of the cathode layer and spaced apart from the anode layer; and a plurality of connection plates which are alternately stacked with the plurality of single body fuel cells and in which one surface of each of the plurality of connection plates is in contact with the anode layer and the other surface thereof is in contact with the connection member.

In this aspect, the connection plates may include an upper connection plate disposed at an uppermost portion of the fuel cell stack and having a lower surface thereof in contact with the connection member, a lower connection plate disposed at a lowermost portion of the fuel cell stack and having an upper surface thereof in contact with the anode layer, and an intermediate connection plate disposed between the single body fuel cells and having an upper surface thereof in contact with the anode layer and a lower surface thereof in contact with the connection member.

In this aspect, the single body support may include a porous metal.

As such, the porous metal may be selected from the group consisting of iron, copper, aluminum, nickel, chromium, alloys thereof and combinations thereof.

In this aspect, the connection plates may include a porous metal.

As such, the porous metal may be selected from the group consisting of iron, copper, aluminum, nickel, chromium, alloys thereof and combinations thereof.

In this aspect, the cathode layer, the electrolyte layer and the anode layer may be formed only on an outer surface of the cylindrical supports.

As such, the anode layer may be spaced apart by a predetermined interval from the connector.

In this aspect, the connector may be formed to be shorter than the cylindrical supports.

In this aspect, the connector may have a first fuel supply passage formed in a direction in which the single body support and the connection plates are stacked, and the connection plates may have a second fuel supply passage formed in the direction in which the single body support and the connection plates are stacked.

As such, the first fuel supply passage and the second fuel supply passage may be formed to be aligned with each other.

In this aspect, the connection plates may have a thermometer at a position spaced apart by a predetermined distance from a portion in contact with the connection member.

Also, the fuel cell stack may further include through holes formed perpendicularly at the same position in the plurality of connection plates to be aligned with each other, a support shaft fitted into the through holes, and a fixing member provided at both ends of the support shaft to fixedly hold the plurality of connection plates and the plurality of single body fuel cells.

### BRIEF DESCRIPTION OF THE DRAWINGS

The features and advantages of the present invention will be more clearly understood from the following detailed description taken in conjunction with the accompanying drawings, in which:

FIG. 1 is a view showing the operating principle behind a fuel cell;

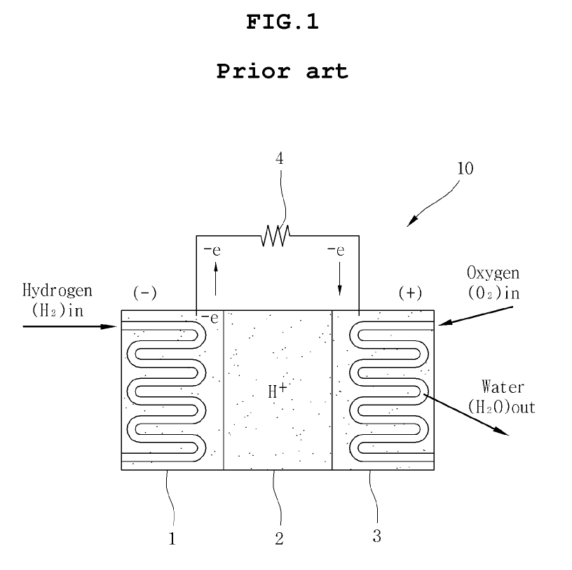

FIG. 2 is a cross-sectional view showing a single body fuel cell according to an embodiment of the present invention;

FIG. 3 is a cross-sectional view showing a single body fuel cell according to another embodiment of the present invention;

FIG. 4 is a perspective view showing the single body fuel cell according to the embodiment of the present invention;

FIG. 5 is a cross-sectional view showing a fuel cell stack including single body supports according to the embodiment of the present invention; and

FIG. 6 is a perspective view showing the fuel cell stack including the single body supports according to the embodiment of the present invention.

### DESCRIPTION OF SPECIFIC EMBODIMENTS

Hereinafter, a detailed description will be given of embodiments of the present invention with reference to the accompanying drawings. Throughout the drawings, the same reference numerals refer to the same or similar elements, and redundant descriptions are omitted. Also in the drawings, O₂ and H₂ are used merely for purposes of illustration to specify the operative procedure of a fuel cell but the type of gas supplied to an anode or an oxygen electrode is not restricted. In the description, the terms “upper”, “lower”, “first”, “second” and so on are used only to distinguish one element from another element, and the elements are not defined by the above terms. Also in the description, in the case where known techniques pertaining to the present invention are regarded as unnecessary because they make the characteristics of the invention unclear and also for the sake of description, the detailed descriptions thereof may be omitted.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

According to the present invention, a fuel cell stack is fabricated by alternately stacking a plurality of single body fuel cells 100 and a plurality of connection plates 200. Thus, the single body fuel cells 100 for producing current will be first described, and then the connection plates 200 which complete the fuel cell stack along with the single body fuel cells 100 will be described.

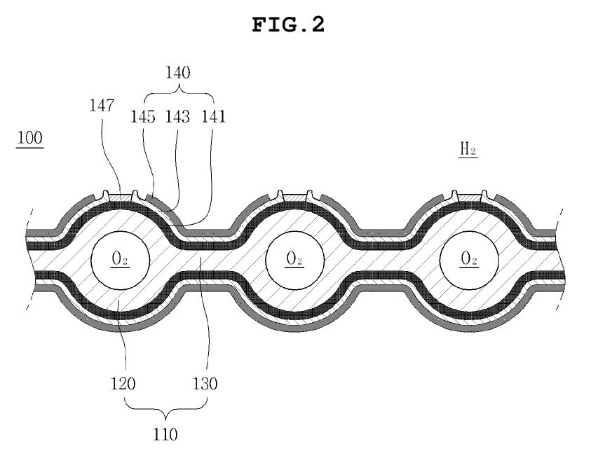

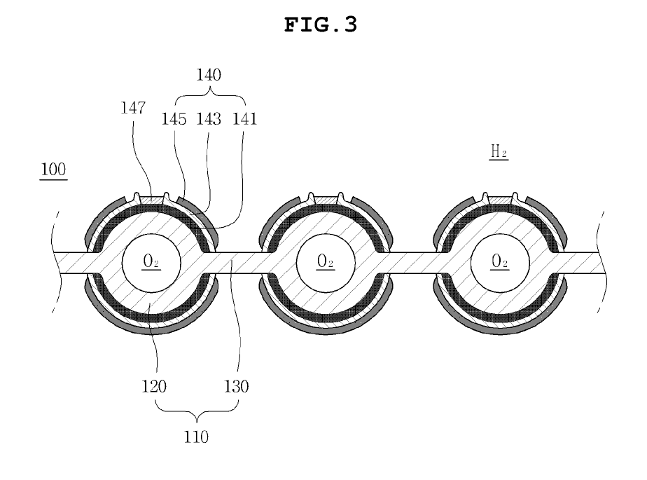

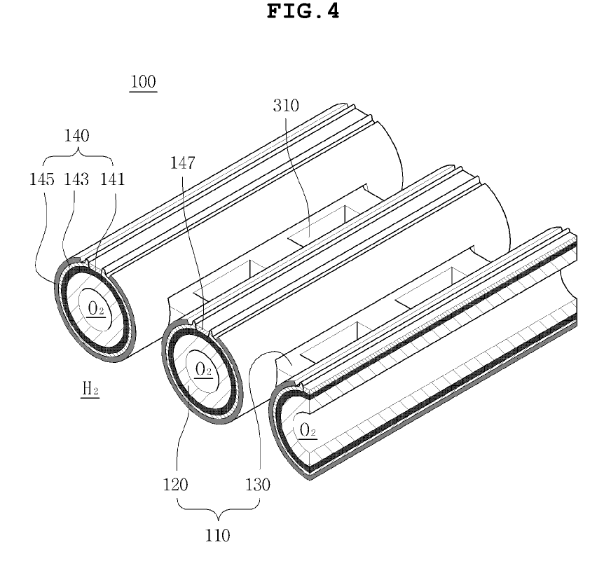

FIG. 2 is a cross-sectional view showing a single body fuel cell according to an embodiment of the present invention, and FIG. 3 is a cross-sectional view showing a single body fuel cell according to another embodiment of the present invention. FIG. 4 is a perspective view showing the single body fuel cell according to the embodiment of the present invention. With these drawings, the single body fuel cell 100 according to the present invention is specified below.

As shown in FIG. 2 or 3, the single body fuel cell 100 according to the embodiment of the present invention includes a single body support 110 composed of a plurality of cylindrical supports 120 and connectors 130 for connecting the plurality of cylindrical supports 120 in parallel, a unit cell 140 composed of a cathode layer 141, an electrolyte layer 143 and an anode 145 which are sequentially formed on an outer surface of the single body support 110, and connection members 147 which protrude outward from the cathode layer 141 on one side of the outer surface of the cathode layer 141 and are spaced apart from the anode layer 145.

The single body support 110 plays a role in supporting the unit cell 140 (including the cathode layer 141, the electrolyte layer 143 and the anode layer 145). As shown in FIG. 2, because the plurality of unit cells 140 is actually supported by one support, the cell structure is stable and the cell stack is easily manufactured. Also, the single body support is more stable in terms of connection to the connection plate 200 to collect current than when using a conventional support. In the present invention, the single body support 110 includes the cylindrical supports 120 and the connectors 130 for connecting the cylindrical supports 120 in parallel. As such, the single body support 110 may be manufactured by simultaneously producing the cylindrical supports 120 and the connectors 130 through a unit extrusion process, or by separately forming the cylindrical supports 120 and the connectors 130 and then connecting them to each other. These methods are merely illustrative, and other methods may be used as long as the final shape of the resultant support is the same as that of the single body support 110, which should also fall within the scope of the present invention.

In order to produce current, air should be transferred to the cathode layer 141. In the single body fuel cell 100 according to the present embodiment, the single body support 110 receives air from a metal manifold and then transfers the air to the cathode layer 141. Thus, the single body support 110 may be made of porous metal which is gas permeable and which is easily connected to a metal manifold. The porous metal may include metal foam, plate or metal fiber. In consideration of the performance and strength of the fuel cell, the porous metal is selected from the group consisting of iron, copper, aluminum, nickel, chromium, alloys thereof and combinations thereof.

It is difficult to deliver air to the unit cell 140 formed on the connectors 130 and to actually produce current. Also when the unit cell 140 is formed on the connectors 130, in the course of subsequent stacking, the anode layer 145 formed on the outermost portion of the connectors 130 may come into contact with connection plates 200 in contact with the connection members 147, undesirably causing a short. Hence, as shown in FIG. 3, the unit cell 140 is desirably formed only on the cylindrical supports 120 of the single body support 110. In this case, the connectors 130 are formed to pass through the cathode layer 141, the electrolyte layer 143 and the anode layer 145. In order to prevent a short from occurring as a result of electrical conduction between the cathode layer 141 and the anode layer 145 happening through the connectors 130, the anode layer 145 may be spaced apart by a predetermined interval from the connectors 130, or an insulating layer (not shown) may be formed between the anode layer 145 and the connectors 130.

In addition, fuel should be supplied to the anode layer 145. In the single body fuel cell 100 according to the present embodiment, because the anode layer 145 is formed at an outermost position, fuel is supplied from outside the fuel cell. In the case where single body fuel cells 100 according to the present invention are stacked in a multilayer form, the connectors 130 of the single body support 110 may block the flow of fuel in a perpendicular direction, undesirably deteriorating performance of the fuel cell. For this reason, as shown in FIG. 4, the connectors 130 may be processed to be shorter than the cylindrical supports 120, so that fuel efficiently flows in the perpendicular direction. The connectors 130 may be processed by simultaneously producing the cylindrical supports 110 and the connectors 130 through extrusion and then performing cutting, or by separately forming shorter connectors 130 and then connecting them to the cylindrical supports 110. Also, first fuel supply passages 310 passing through the connectors 130 in the direction in which the single body supports 110 are stacked may be formed, thus facilitating the flow of fuel. Such first fuel supply passages 310 may be processed through drilling or cutting. The first fuel supply passages 310 facilitate the flow of fuel in the perpendicular direction along with second fuel supply passages 320 formed in the connection plates 200 which will be described later, ultimately increasing performance of the single body fuel cell 100.

The process of sequentially forming the cathode layer 141, the electrolyte layer 143 and the anode layer 145 to thus complete the unit cell 140 is briefly described below. The cathode layer 141 is formed on the outer surface of the single body support 110. The cathode layer 141 may be formed by applying LSM (Strontium doped Lanthanum Manganite) or LSCF ((La,Sr)(Co,Fe)O₃) using slip coating or plasma spray coating and then sintering it at 1200˜1300° C. Also, the electrolyte layer 143 is formed on the outer surface of the cathode layer 141. The electrolyte layer 143 may be formed by applying YSZ (Yttria stabilized Zirconia) or ScSZ (Scandium stabilized Zirconia), GDC or LDC on the outer surface of the cathode layer 141 using slip coating or plasma spray coating and then sintering it at 1300˜1500° C. Also, the anode layer 145 is formed on the outer surface of the electrolyte layer 143. The anode layer 145 may be formed by applying NiO—YSZ (Yttria stabilized Zirconia) on the outer surface of the electrolyte layer 143 using slip coating or plasma spray coating and then heating it to 1200˜1300° C.

The connection members 147 may be typically formed after sequential formation of the cathode layer 141, the electrolyte layer 143 and the anode layer 145 on the single body support 110. The connection members 147 function to transfer current produced in the cathode layer 141 to the connection plates 200 by coming into contact with the connection plates 200. The connection members 147 may be formed to protrude outward from the cathode layer 141 on one side of the outer surface of the cathode layer 141 and thus may come into contact with the connection plates 200. The connection members 147 are used to collect the current produced in the cathode layer 141, and it is thus desirable that they be made of a conductive material. In order to prevent a short with the anode layer 145, the connection members 147 may be spaced apart by a predetermined interval from the anode layer 145, or an insulating layer (not shown) may be disposed between the anode layer 145 and the connection members 147. Taking into consideration the contact with the connection plates 200, all of the connection members 147 may be formed to protrude upward.

Below, the connection plates 200 which are alternately stacked with the single body fuel cells 100 to thus complete the fuel cell stack are described.

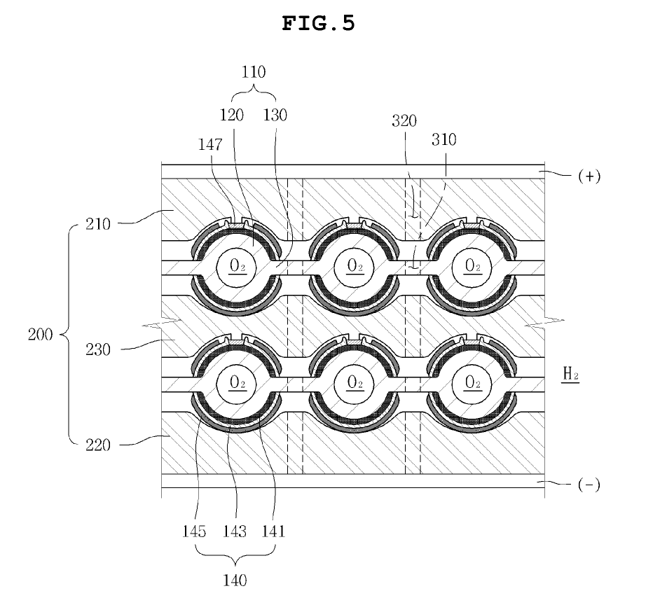

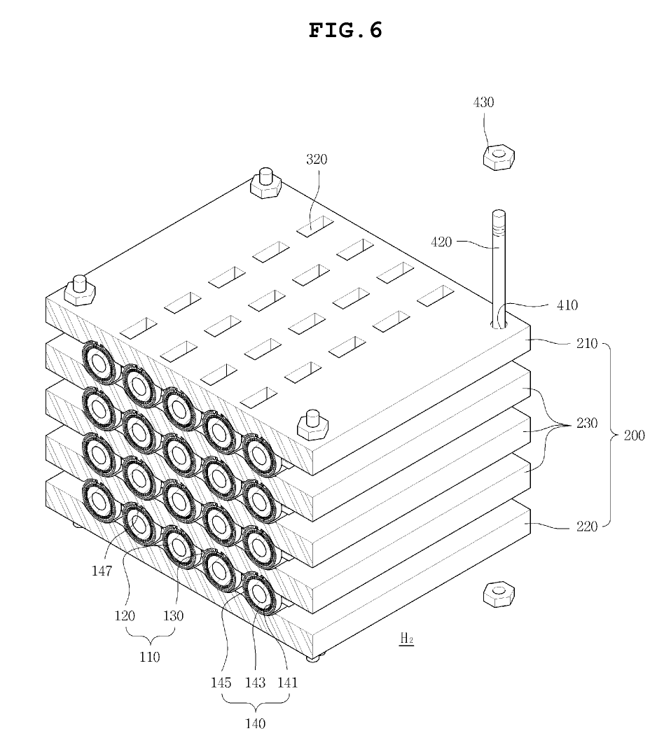

FIG. 5 is a cross-sectional view showing the fuel cell stack including single body supports according to the embodiment of the present invention, and FIG. 6 is a perspective view showing the fuel cell stack including the single body supports according to the embodiment of the present invention.

As shown in FIG. 5 or 6, the plurality of connection plates 200 according to the embodiment of the present invention is alternately stacked with the plurality of single body fuel cells 100 such that one surface of the connection plates 200 is in contact with the anode layer 145 and the other surface thereof is in contact with the connection members 147.

The connection plates 200 also function to collect current produced in the single body fuel cells 100, in addition to stacking with the single body fuel cells 100 to thus form the fuel cell stack. Accordingly, the connection plates 200 should be in contact with the anode layer 145 and the connection members 147 protruding from the cathode layer 141. However, in the case where both the anode layer 145 and the connection members 147 of the same single body fuel cell 100 come into contact with the same connection plate 200, a short may occur.

With reference to FIG. 5, in order to prevent the generation of a short, the connection plate 200 disposed under the single body fuel cell 100 is in contact with the anode layer 145 but must not come into contact with the connectors 130 of the single body support 110. Also, the connection plate 200 disposed on the single body fuel cell 100 is in contact with the connection members 147 but must not come into contact with the anode layer 145. Thus, the portions of the connection plate 200 in contact with the connection members 147 may be formed to protrude, or the connection members 147 may be formed to further protrude compared to the anode layer 145.

The connection plates 200 include an upper connection plate 210 disposed at the uppermost portion of the fuel cell stack, a lower connection plate 220 disposed at the lowermost portion of the fuel cell stack, and an intermediate connection plate 230 disposed between the plurality of single body fuel cells 100. As such, the upper surface of the intermediate connection plate 230 may be in contact with the anode layer 145, and the lower surface thereof may be in contact with the connection members 147. Moreover, because the single body fuel cell 100 is not disposed on the upper surface of the upper connection plate 210, only the lower surface of the upper connection plate 210 may be in contact with the connection members 147. In contrast to the upper connection plate 210, the single body fuel cell 100 is not disposed on the lower surface of the lower connection plate 220, and thus only the upper surface of the lower connection plate 220 may be in contact with the anode layer 145.

As shown in FIG. 5, in an illustrative case where two single body fuel cells 100 and three connection plates 200 are stacked, the fuel cell stack according to the present invention is configured such that the lower connection plate 220, the anode layer 145, the connection members 147, the intermediate connection plate 230, the anode layer 145, the connection members 147 and the upper connection plate 210 are sequentially connected. Because two single body fuel cells 100 are connected in series, negative current (the anode layer 145) may be collected in the lower connection plate 220 whereas positive current (the cathode layer 141) may be collected in the upper connection plate 210. Furthermore, it is a matter of course that the number of stacked single body fuel cells 100 be increased, resulting in higher voltage.

The connection plates 200 also function to transfer external fuel to the anode layer 145, in addition to collecting the current produced in the single body fuel cells 100. Thus, the connection plates 200 may be formed of a porous metal which is gas permeable and which enables the collection of current. As such, the porous metal includes metal foam, plate or metal fiber. In consideration of the performance and strength of the fuel cell, the porous metal is selected from the group consisting of iron, copper, aluminum, nickel, chromium, alloys thereof and combinations thereof.

In the case where the single body fuel cells 100 are stacked in a multilayer form using the connection plates 200, the connection plates 200 may block the flow of fuel in the perpendicular direction and thus performance of the fuel cell may be deteriorated. For this reason, as shown in FIG. 6, second fuel supply passages 320 may be formed to pass through the connection plates 200, thus facilitating the flow of fuel. The second fuel supply passages 320 may be processed through drilling or cutting. Moreover, the first fuel supply passages 310 and the second fuel supply passages 320 may be formed to be aligned with each other, so that the fuel more efficiently flows from the uppermost portion of the fuel cell stack to the lowermost portion thereof.

The connection plate 200 may include a thermometer at a position spaced apart by a predetermined distance from a portion in contact with the connection member 147 as a precautionary measure against the generation of hot spots at any portion of the single body fuel cell 100. In the case where the performance of the fuel cell is deteriorated, a portion of the fuel cell at excessively high temperature is discerned using the thermometer and thus such a problematic portion of the fuel cell may be rapidly located and fixed. Because the normal operating temperature of the single body fuel cell 100 is considerably high, the thermometer should be provided at a position spaced apart by a predetermined distance from the portion in contact with the connection member 147 in the connection plate 200.

In order to more stably fabricate the fuel cell stack, through holes 410 formed perpendicularly at the same position in the plurality of connection plates 200 to be aligned with each other, support shafts 420 fitted into the through holes 410, and fixing members 430 provided at both ends of the support shafts 420 to thus fixedly hold the plurality of connection plates 200 and the plurality of single body fuel cells 100 are used. The through holes may be formed inside four corners of the connection plates 200 having a quadrangular shape, and the support shafts 420 having screw helixes processed at both ends thereof may be fitted into the trough holes and fastened by bolts used as the fixing members 430. Also, the upper and lower portions of the fuel cell stack may be fixedly held using the fixing members 430 and the support shafts 420, and thus the connection members 147 and the anode layer 145 may make more certain contact with the connection plates 200, thus increasing current collection efficiency.

As described hereinbefore, the present invention provides a fuel cell stack having a single body support. According to the present invention, the fuel cell stack includes single body supports, and is thus more stably supported than when using a conventional ceramic support, thus increasing durability and reliability.

According to the present invention, because connection plates are made of metal, current can be advantageously collected using the connection plates in lieu of an additional current collector. Furthermore, metal is more easily molded compared to ceramic, and thus the fuel cell stack can be variously shaped. In the fuel cell stack, fuel cells can be scaled up, and the single body supports are made of metal and may be welded and hermetically sealed at the time of bonding to a metal manifold, thus preventing gas from leaking.

According to the present invention, the single body supports and the connection plates are made of porous metal and fuel supply passages are provided, thus efficiently supplying fuel to an anode layer and air to a cathode layer.

According to the present invention, a thermometer able to measure the temperature of respective unit cells is provided. Thus, even when performance of the fuel cell is deteriorated attributable to the formation of hot spots, the problematic unit cell can be easily located.

According to the present invention, the anode layer is formed on the outermost portion of the fuel cell, in which a hydrogen atmosphere is outside the fuel cell. Therefore, the connection plates can be formed using a metal material which is inexpensive, in lieu of a conductive ceramic material to prevent oxidation.

Although the embodiments of the present invention regarding the fuel cell stack having the single body support have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A fuel cell stack, comprising:
a plurality of single body fuel cells each including:
a single body support composed of a plurality of cylindrical supports and a connector for connecting the plurality of cylindrical supports in parallel,
a unit cell having a cathode layer, an electrolyte layer and an anode layer sequentially formed on an outer surface of the single body support, and
a connection member formed to protrude outward from the cathode layer on one side of an outer surface of the cathode layer and spaced apart from the anode layer; and
a plurality of connection plates which are alternately stacked with the plurality of single body fuel cells and in which one surface of each of the plurality of connection plates is in contact with the anode layer and the other surface thereof is in contact with the connection member.

2. The fuel cell stack as set forth in claim 1, wherein the plurality of connection plates comprises:
an upper connection plate disposed at an uppermost portion of the fuel cell stack and having a lower surface thereof in contact with the connection member;
a lower connection plate disposed at a lowermost portion of the fuel cell stack and having an upper surface thereof in contact with the anode layer; and
an intermediate connection plate disposed between the single body fuel cells and having an upper surface thereof in contact with the anode layer and a lower surface thereof in contact with the connection member.

3. The fuel cell stack as set forth in claim 1, wherein the single body support comprises a porous metal.

4. The fuel cell stack as set forth in claim 3, wherein the porous metal is selected from the group consisting of iron, copper, aluminum, nickel, chromium, alloys thereof and combinations thereof.

5. The fuel cell stack as set forth in claim 1, wherein the connection plates comprise a porous metal.

6. The fuel cell stack as set forth in claim 5, wherein the porous metal is selected from the group consisting of iron, copper, aluminum, nickel, chromium, alloys thereof and combinations thereof.

7. The fuel cell stack as set forth in claim 1, wherein the cathode layer, the electrolyte layer and the anode layer are formed only on an outer surface of the cylindrical supports.

8. The fuel cell stack as set forth in claim 7, wherein the anode layer is spaced apart by a predetermined interval from the connector.

9. The fuel cell stack as set forth in claim 1, wherein the connector is formed to be shorter than the cylindrical supports.

10. The fuel cell stack as set forth in claim 1, wherein the connector has a first fuel supply passage formed in a direction in which the single body support and the connection plates are stacked, and the connection plates have a second fuel supply passage formed in the direction in which the single body support and the connection plates are stacked.

11. The fuel cell stack as set forth in claim 10, wherein the first fuel supply passage and the second fuel supply passage are formed to be aligned with each other.

12. The fuel cell stack as set forth in claim 1, wherein the connection plates have a thermometer at a position spaced apart by a predetermined distance from a portion in contact with the connection member.

13. The fuel cell stack as set forth in claim 1, further comprising:
through holes formed perpendicularly at a same position in the plurality of connection plates to be aligned with each other;
a support shaft fitted into the through holes; and
a fixing member provided at both ends of the support shaft to fixedly hold the plurality of connection plates and the plurality of single body fuel cells.
